(19) United States
(12) Patent Application Publication
(10) Pub. No.: US 2019/0008277 A1
(43) Pub. Date: Jan. 10, 2019

(54) OVERTURN PREVENTING DEVICE

(71) Applicant: KYB CORPORATION, Minato-ku, Tokyo (JP)

(72) Inventors: Shinichi SEKINE, Minato-ku, Tokyo (JP); Akihisa OTA, Minato-ku, Tokyo (JP); Masaya UNE, Minato-ku, Tokyo (JP); Yukiko ISHIHARA, Minato-ku, Tokyo (JP); Atsushi TOYOUCHI, Minato-ku, Tokyo (JP); Chika IIDA, Minato-ku, Tokyo (JP); Yukio KATO, Minato-ku, Tokyo (JP)

(73) Assignee: KYB CORPORATION, Minato-ku, Tokyo (JP)

(21) Appl. No.: 16/064,755

(22) PCT Filed: Dec. 22, 2016
(86) PCT No.: PCT/JP2016/088457

§ 371 Date: Jun. 21, 2018

(30) Foreign Application Priority Data
Dec. 25, 2015 (JP) 2015-254392

(51) Int. Cl. A47B 97/00

(52) U.S. Cl. CPC A47B 97/00; F16F 9/516; A47B 2097/008

(57) ABSTRACT

Providing an overturn preventing device in which a plurality of dampers can be mounted between a top surface of an article and a ceiling and which can suppress increase in working man-hour and increase in an installation space. The overturn preventing device includes a plurality of dampers mounted between a top surface and a piece of furniture installed on an installation surface and a ceiling. The dampers each have first and second ends and all of the first ends are coupled to the article-side base. The second ends of the dampers are coupled to one or a plurality of ceiling-side bases.

### TECHNICAL FIELD

The present invention relates to an overturn preventing device.

### BACKGROUND ART

Patent Document 1 discloses a conventional overturn preventing device. The overturn preventing device includes a damper and a pair of bases. The damper is mounted between a top surface of a piece of furniture installed on a floor and a ceiling. The damper has two ends respectively supported by the paired bases to be rotatable about rotation axes. One of the bases abuts against the top surface of the furniture, and the other base abuts against the ceiling. As a result, in this overturn preventing device, when the furniture is tilted by shaking of earthquake or the like in a direction parallel to a rotation direction of the damper, the damper is rotated about the rotation axes relative to the bases so that the bases can be maintained in abutment against the top surface of the furniture and the ceiling respectively. As a result, this overturn preventing device can apply a damping force of the damper to the furniture thereby to suppress the tilt of the furniture and prevent the furniture from overturn.

### PRIOR ART DOCUMENT

### Patent Documents

Patent Document 1: Japanese Patent Application Publication No. JP 2015-6330

### SUMMARY OF THE INVENTION

### Problem to be Overcome by the Invention

Patent Document 1 discloses an example in which a single damper is installed between the top surface of an article and the ceiling. However, it may be desirable to mount two or more dampers. However, a manner of installing two or more overturn preventing devices as disclosed in Patent Document 1 increases more than double working man-hour due to an increase in the number of overturn preventing devices to be installed, resulting in a very large burden imposed on a worker in execution of the installation work. Moreover, in this manner, as many bases as the number of dampers need to be placed on the top surface of the article, so that a large placement space needs to be ensured on the top surface of the article. It is difficult to apply the manner to an article which cannot ensure a sufficient space on the top surface thereof.

The present invention was made in view of the above-described circumstances in the conventional art and has an object to provide an overturn preventing device which can allow a plurality of dampers to be mounted between the top surface of the article and the ceiling and can suppress an increase in working man-hour and an increase in the installation space.

### Means for Overcoming the Problem

An overturn preventing device in accordance with the present invention includes a plurality of dampers to be mounted between a top surface of an article installed on an installation surface and a ceiling. The dampers each have first and second ends. All of the first ends of the dampers are coupled to an article-side base to be placed on the top surface of the article. The second ends of the dampers are coupled to one or a plurality of ceiling-side bases.

The overturn preventing device in accordance with the invention includes a plurality of dampers. The dampers each have first and second ends, and all of the first ends of the dampers are coupled to the article-side base. When the overturn preventing device is to be mounted between the top surface of the article and the ceiling, individual bases need not be provided for the respective dampers at the article side, and a common article-side base can be used. As a result, even when the number of dampers is increased, increase in an area of the top surface of the article necessary for installation of the base can be suppressed. Moreover, the plural dampers are coupled to the article-side base, so that the dampers can be controlled in a collective manner. As a result, when the base is to be positioned and placed on the article, time and effort to position and place the individual bases can be eliminated.

Accordingly, a plurality of dampers can be mounted between the top surface of the article and the ceiling, and increase in working man-hour and increase in an installation space can be suppressed.

The second ends of the dampers may be individually coupled to the respective ceiling-side bases. According to this construction, with respect to the article side, the common base is used with the result that increase in working man-hour and increase in an installation space can be suppressed. With respect to the ceiling side, the bases are provided for the respective dampers with the result that the degree of freedom in the installation of the overturn preventing device can be increased. In particular, with respect to the article-side base which is subject to the restriction by the size, shape and the like of the top surface of the article, it is possible to adopt a configuration easily adaptable to the restriction due to the article by common usage of the article-side base. On the other hand, with respect to the ceiling side where there may be more space allowance as compared with the article side, the position of the base can be set for each damper so that fine adjustment can be made.

The second ends of a plurality of or all of the dampers may be coupled to different positions of a common ceiling-side base. According to this construction, the number of parts can be reduced by the common usage of the also at the ceiling side with the result that increase in working man-hour can be suppressed.

The ceiling-side bases may be respectively disposed at both sides of an imaginary vertical line passing a central part of the article-side base in a state where the overturn preventing device is mounted between the top surface of the article and the ceiling. In this construction, one of the dampers is mounted while being inclined to one of the sides of the imaginary line on the basis of the article-side base, and the other damper is mounted while being inclined to the other side. According to this construction, even when the article is tilted to the one side or to the other side, a force tilting the article can be effectively dampened with the result that tilt of the article can be suppressed.

The damper disposed at one of the sides of the imaginary line may have a first inclination to a vertical direction, and the damper disposed at the other side of the imaginary line may have a second inclination to the vertical direction. The first and second inclinations may be equal to each other. According to this construction, the force tilting the article to the one side and the force tilting the article to the other side both can be dampened in a balanced manner.

The article may have a bottom which is formed into an elongated shape such that a predetermined direction perpendicular to a height direction of the article is a longitudinal direction. A center position of the bottom and a location range of the article-side base may overlap in a direction perpendicular to the height direction of the article and the longitudinal direction. The article is tilted easily in the direction perpendicular to the longitudinal direction of the bottom thereof, so that uplift due to the tilt is likely to occur at both ends of the bottom in the perpendicular direction. Accordingly, when the overturn preventing device is configured so that the center position of the article bottom (the above-mentioned center position in the perpendicular direction) is located beneath the article-side base, the uplift can be prevented from leaning to one of the ends of article bottom. This can prevent tilt at both sides in the direction perpendicular to the longitudinal direction of the article in a balanced manner.

### BRIEF DESCRIPTION OF THE DRAWINGS

FIG. 1 is a side view of the overturn preventing device of a first embodiment, mounted between a top surface of furniture and the ceiling;

FIG. 2 is a front view of the overturn preventing device of the first embodiment, mounted between the top surface of the furniture and the ceiling;

FIG. 3 is a partial cross section of a damper of the overturn preventing device of the first embodiment and an article-side base;

FIG. 4 is an exploded perspective view of the damper and the article-side base of the overturn preventing device of the first embodiment;

FIG. 5 is a partial cross section of the damper of the overturn preventing device of the first embodiment and a ceiling side base;

FIG. 6 is a side view of the overturn preventing device of the first embodiment, the ceiling, the furniture and the floor surface;

FIG. 7 is a plan view conceptually showing the relationship between the article-side base and the bottom of the furniture when the overturn preventing device of the first embodiment is mounted between the top surface of the furniture and the ceiling;

FIG. 8 is a side view of the overturn preventing device of a second embodiment, mounted between the top surface of furniture and the ceiling; and

FIG. 9 is a front view of the overturn preventing device of the second embodiment, mounted between the top surface of the furniture and the ceiling.

### BEST MODE FOR CARRYING OUT THE INVENTION

A first embodiment of the overturn preventing device of the present invention will be described with reference to the drawings.

### First Embodiment

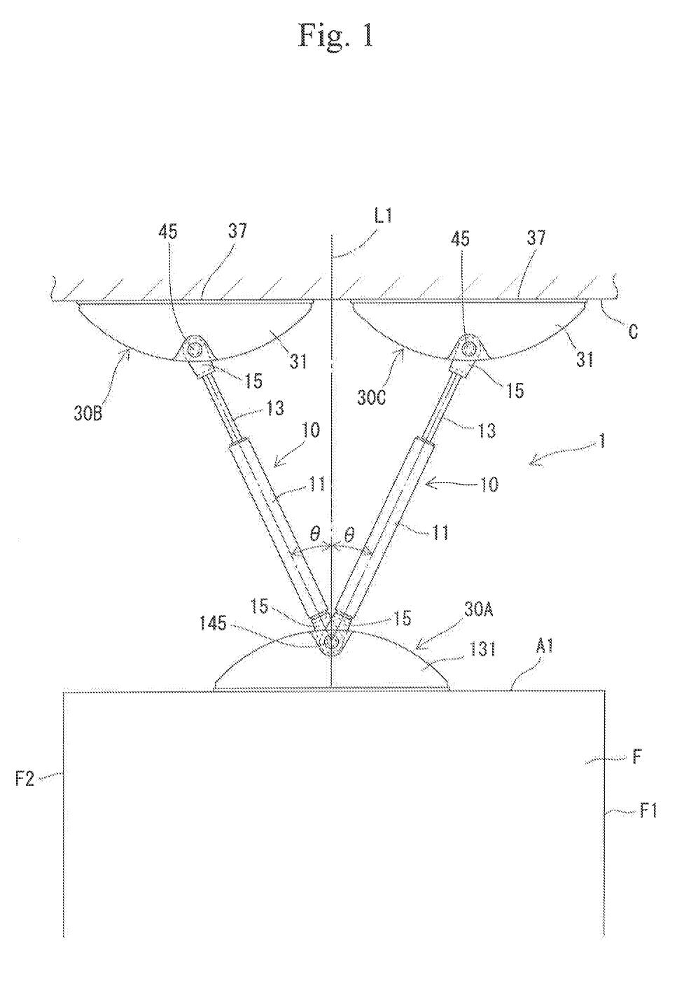

At least one overturn preventing device 1 of the first embodiment is mounted between a top surface of a piece of furniture F and a ceiling C, as illustrated in FIG. 1. The furniture F is placed on a floor surface Fr in a manner such that no article is opposed to a front F1 and a back F2 thereof. The furniture F is formed into a rectangular parallelepiped shape and has a door, drawers (neither illustrated) and the like in the front (a right side as viewed in FIG. 1), so that clothes, accessories and the like can be housed in the furniture F.

The furniture F has a rectangle-shaped horizontal section long in a right-left direction (a depthwise direction in FIG. 1). An outer shape of the furniture F is rectangular in a planar view. In the construction, a longitudinal direction of the furniture F as viewed in the planar view (a longer side direction in the rectangular shape) will be referred to as a right-left direction of the furniture (article), and a lateral direction of the furniture F (a shorter side direction in the rectangular shape) will be referred to as a front-back direction of the furniture F (the article). A height direction of the furniture F is perpendicular to the right-left direction and the front-back direction. The furniture F has a bottom B2 with a bottom surface A2 formed into a longitudinal shape. More specifically, an outer shape of the bottom surface A2 (the shape of outer edge as viewed from below) is rectangle.

When the overturn preventing device 1 is not mounted on the furniture F, the furniture F would possibly be tilted frontward (rightward in FIG. 1) by shaking of earthquake or the like thereby to be overturned.

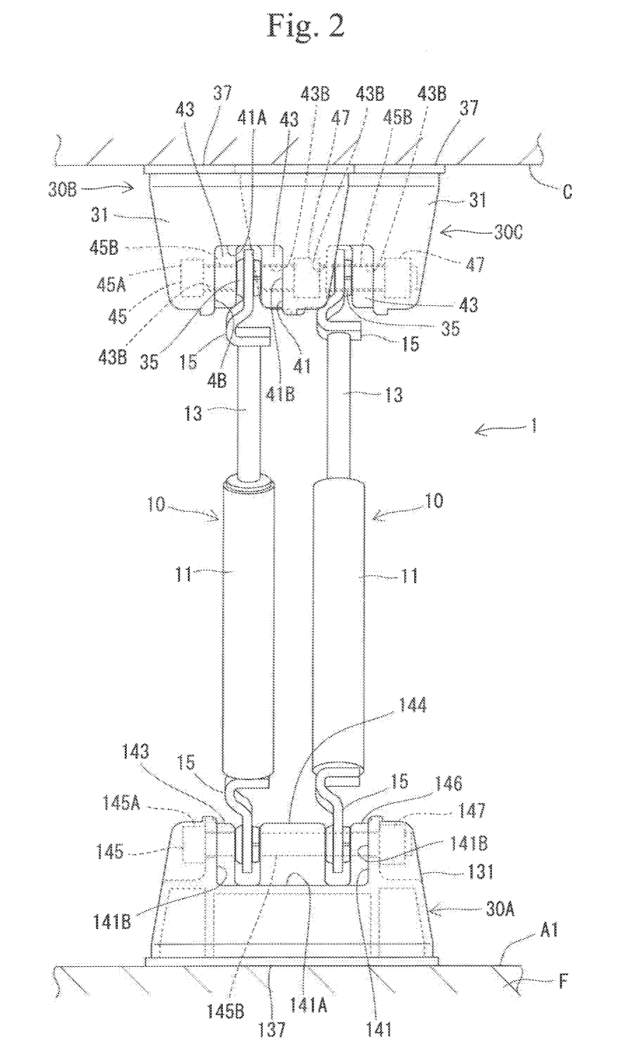

The overturn preventing device 1 includes a plurality of dampers 10, an article-side base 30A and ceiling side bases 30B and 30C, as illustrated in FIGS. 1 and 2.

Two dampers 10 have the same structure in the overturn preventing device 1 illustrated in FIGS. 1, 2 and so on. Each damper 10 includes a cylinder 11, a rod guide (not illustrated), a piston (not illustrated), a rod 13 and two joints 15 respectively provided on both ends of the damper 10. The cylinder 11 is bottomed and has a cylindrical shape. The rod guide closes an opening of the cylinder 11. The piston is slidably housed in the cylinder 11. The rod 13 has a proximal end connected to the piston. The rod 13 is inserted through the rod guide, so that a distal end thereof protrudes out of the cylinder 11. A hydraulic fluid and a compressed gas are enclosed in the cylinder 11. Each joint 15 is formed by bending a flat plate-shaped metal fitting as illustrated in FIGS. 1 to 3. The joints 15 are respectively connected to a bottom of the cylinder 10 and the distal end of the rod 13. Each joint 15 is formed with a through hole 15A extending therethrough in a direction perpendicular to an axis line of the damper 10.

Each damper 10 is a compression damper in which a damping force generated during an extending operation is smaller than a damping force generated during a contracting operation. The extending operation of the damper 10 refers to an operation which increases an amount of protrusion of the rod 13 out of the cylinder 11 and an entire length of the damper 10. Furthermore, the contracting operation of the damper 10 refers to an operation which reduces an amount of protrusion of the rod 13 out of the cylinder 11 and the entire length of the damper 10. An expansion force of the compressed gas enclosed in the cylinder 11 works in an expansion direction of the damper 10.

The following will describe a mechanism of generating a damping force by the damper 10. Since the mechanism has a known structure, diagrammatic representation is eliminated. The cylinder 11 has an interior divided by the piston into a rod side pressure chamber in which the proximal end of the rod 13 is housed and a counter-rod side pressure chamber. The piston is formed with an orifice which is a throttle valve communicating between both pressure chambers. The orifice functions as a damping force generator which applies resistance to a flow of the hydraulic fluid between the rod side pressure chamber and the counter-rod side pressure chamber with the expanding/contracting operation of the damper 10. Furthermore, the piston is formed with a communication path communicating via a check valve with both pressure chambers. The check valve allows the hydraulic fluid to flow from the rod side pressure chamber to the counter-rod side pressure chamber and blocks reverse flow of the hydraulic fluid. Accordingly, the damper 10 has two flow paths of the hydraulic fluid from the rod side pressure chamber to the counter-rod side pressure chamber during the extending operation, that is, one flow path including the orifice and the other flow path including the communication path. On the other hand, the damper 10 has only one flow path of the hydraulic fluid from the counter-rod side pressure chamber to the rod side pressure chamber through the orifice during the contracting operation. Accordingly, the damping force generated by the damper 10 during the extending operation is smaller than the damping force generated by the damper 10 during the contracting operation.

One end of each of the two dampers 10 is coupled to the article-side base 30A placed on the top surface A1 of the furniture F. A joint 15 is connected to a base of the cylinder 11 of each damper 10 and is rotatably coupled to the article-side base 30A.

The article-side base 30A includes a base body 131, a bolt 145 and nut 147 serving as a rotating shaft member, a bush 135 and a slip preventing part 137.

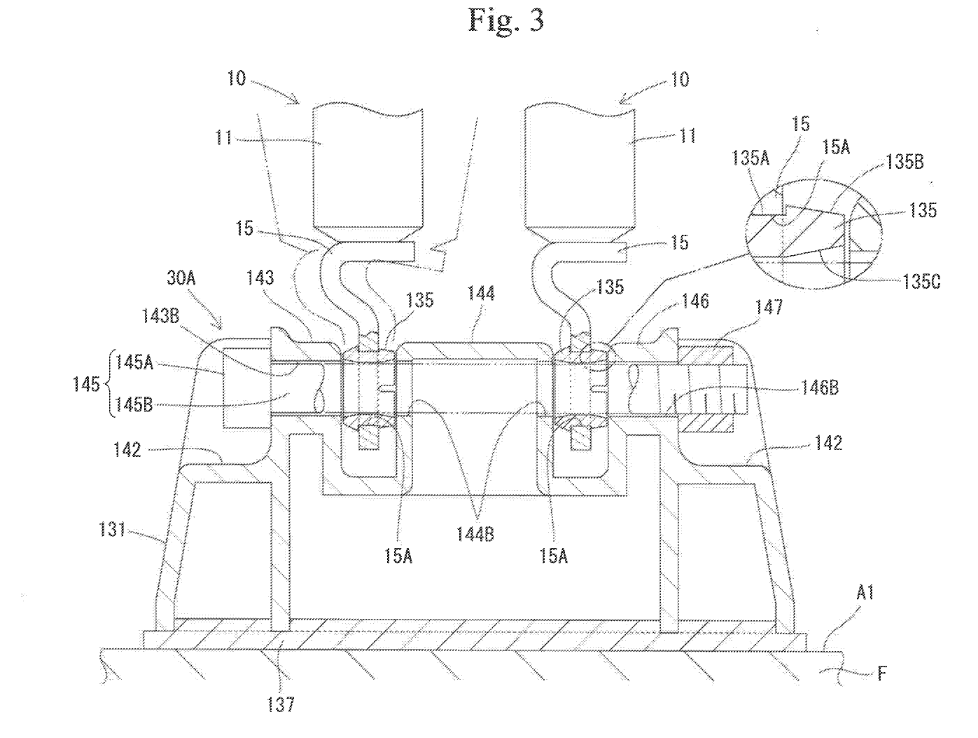

The base body 31 has a rectangular outer shape in a planar view as viewed from above in a state where the article-side base 30A is placed in abutment on the top surface of the furniture F. Hereinafter, a direction in which a long side in the outer shape of the base body 131 extends in this planar view will be referred to as “a long side direction” and a direction in which a short side extends will be referred to as “a short side direction”. Furthermore, in a side view of the article-side base 30A as viewed in the short side direction in the state where the article-side base 30A is placed in abutment on the top surface of the furniture F, the base body 131 has a lower edge which extends straightforward in parallel to the top surface of the furniture F and an upper edge which upwardly bulges from both sides of the lower edge thereby to have an arc-shaped outer shape (refer to FIG. 1). Still furthermore, in a side view of the article-side base 30A as viewed in the long side direction in the state where the article-side base 30A is placed in abutment on the top surface of the furniture F, the base body 131 has a trapezoidal outer shape in which the upper edge is shorter than the lower edge (refer to FIGS. 2 and 3).

In the article-side base 30A, the base body 131 has a groove 141 which is formed in an upper surface thereof and extends in the long side direction (a right-left direction as viewed in FIG. 1 and a depthwise direction as viewed in FIGS. 2 and 3). The groove 141 has a bottom 141A formed so as to be substantially parallel to a surface in contact with the article (a lower surface of the slip preventing part 137) and inner wall surfaces 141B respectively rising from both sides of the bottom 141A substantially in a vertical direction. The groove 141 has a constant width except for a portion formed with convex portions 143, 144 and 146 which will be described later.

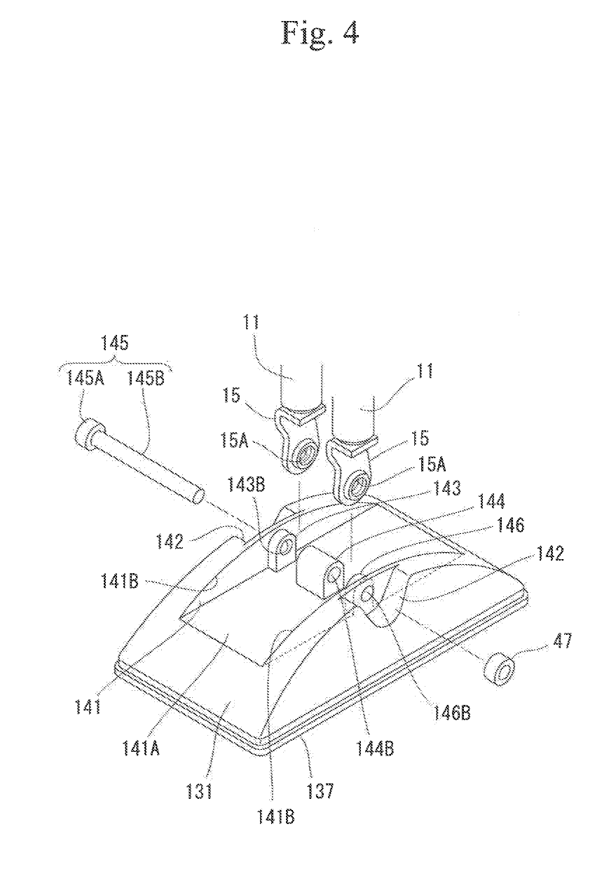

The groove 141 has the paired convex portions 143 and 146 which are formed at a central part thereof in the long side direction to protrude from the bottom 141A and both inner wall surfaces 141B of the groove 141, as illustrated in FIG. 4. The convex portion 144 protruding upward from the bottom 141A is formed between the convex portions 143 and 146. Spaces are respectively defined between the convex portions 143 and 144 and between the convex portions 144 and 146. The joints 15 of the dampers 10 and bushes 135 which will be described later are respectively fitted into the spaces. The spaces communicate with the groove 141. A distance (a dimension of the space in the short side direction) between inner wall surfaces of the convex portions 143 and 144 is slightly longer than a length of each bush 135. A distance (a dimension of the space in the short side direction) between inner wall surfaces of the convex portions 144 and 146 is also slightly longer than the length of each bush 135. The convex portions 143, 144 and 146 respectively have insertion holes 143B, 144B and 146B which are formed to extend therethrough in the short side direction and through which a shaft part 145B of the bolt 145, which will be described later, is inserted.

In the article-side base 30A, the base body 131 has recesses 142 respectively formed in the middle in the long side direction at both sides of the groove 141. The recesses 142 are each open upward and outward with respect to the short side direction. The recesses 142 respectively have sides in which the insertion holes 143B and 146B formed through the convex portions 143 and 146 and are open. The middle convex portion 144 also has a insertion hole 144B which is formed therethrough. The bolt 145 is insertable through the insertion holes 143B, 144B and 146B. A head 145A of the bolt 145 and the nut 147 screwed onto the bolt 145 are respectively disposed in the recesses 142. The recesses 142 are formed to be upwardly spread in the long side direction so that tools can be fitted with the bolt head 145A and the nut 147 from above. The bolt 145 is inserted through the insertion holes 143B, 144B and 146B of the respective convex portions 143, 144 and 146 from one side of the base body 131, and the nut 147 is screwed onto the bolt 145 at the other side of the base body 131. A central axis of the bolt 145 serves as a rotation axis of the dampers 10. In other words, two dampers 10 are rotated about the same rotation axis.

The base body 131 has a hollow interior, which is formed with a plurality of ribs extending in parallel to the short side direction and a plurality of ribs extending in parallel to the long side direction so that the ribs extending in parallel to the short side direction intersect with the ribs extending in parallel to the long side direction.

The bushes 135 are substantially cylindrical in shape as illustrated in FIG. 3. The bushes 135 are elastic bodies. The bushes 135 each have a length that is slightly smaller than distances between the inner wall surfaces of the convex portions 143, 144 and 146 provided in the base body 131. Each bush 135 is formed with a concave portion 135A going around a central part of the outer peripheral surface thereof. The concave portion 135A has an outer diameter that substantially equals an inner diameter of the through hole 15A formed through the joint 15 of the damper 10. The bush 135 has potions rising from both ends of the concave portion 135A which portions have outer diameters larger than the inner diameter of the through hole 15A of the joint 15. Furthermore, both ends of the bush 135 have respective outer peripheral surfaces 135B the diameters of which are outwardly reduced. As a result, the bush 135 is inserted into the through hole 15A of the joint 15 of the damper 10 while being elastically deformed. The concave portion 135A is then fitted into the through hole 15A so that the bush 135 is attached to the joint 15 of the damper 10.

The central part of the bush 135 has an inner diameter slightly larger than an outer diameter of the shaft part 145B of the bolt 145. Both ends of the bush 135 have inner peripheral surfaces 135C the diameters of which are outwardly enlarged. Accordingly, the bush 135 is rotatable about the shaft part 145B of the bolt 145. Furthermore, the bush 135 is inclinable with respect to the shaft part 145B of the bolt 145 to the extent that the inner peripheral surfaces 135C of both ends thereof having enlarged diameters abut against an outer peripheral surface of the shaft part 145B of the bolt 145. In other words, the dampers 10 with the bush 135 attached to the joint 15 is rotatable about the shaft part 145B of the bolt 145 and swingable in a direction intersecting the rotation direction. More specifically, the damper 10 is swung due to a dimensional allowance and the enlarged diameter of the inner peripheral surfaces 135C. Furthermore, by the elastic deformation of the bush 135, the dampers 10 can be swung more largely in the direction intersecting the rotation direction.

The slip preventing part 137 has an outer shape which is similar to and slightly larger than an outer shape of the base body 131 (a rectangular shape), as illustrated in FIGS. 1 to 4. The slip preventing part 137 is made of rubber. In the article-side base 30A placed in abutment on the top surface of the furniture F, the slip preventing part 137 is fitted in a lower opening of the base body 131. Furthermore, the slip preventing part 137 is substantially flat in shape. In the slip preventing part 137, a surface which abuts against the top surface A1 of the furniture F is flat and an oppositely directed surface (the surface opposed to the base body 131) is formed with a fitting groove according to an outer peripheral wall of the base body 131 and the inner ribs. The slip preventing part 137 is detachably attached to the base body 131 by an elastic force thereof.

The ceiling-side bases 30B and 30C have the same structure. Hence, only the ceiling-side base 30B will be described in detail, and the detailed description of the ceiling-side base 30C will be eliminated as the ceiling-side base 30C has the same structure as the ceiling-side base 30B.

The ceiling-side base 30B includes a base body 31, a bolt 45 and nut 47, a bush 35 and a slip preventing part 37, as illustrated in FIG. 2.

The base body 31 of the ceiling-side base 30B has a contact surface with the ceiling (a contact surface of the slip preventing part 37) and is formed with a groove 41 which is located in a surface side opposed to the contact surface and extends in parallel to the contact surface and in a direction perpendicular to the central axis of the bolt 45. The groove 41 has a bottom 41A parallel to the contact surface with the ceiling (the contact surface of the slip preventing part 37) and inner wall surfaces 41B respectively provided substantially vertically at both sides of the bottom 41A. The groove 41 has a constant width except for a portion formed with the paired convex portions 43.

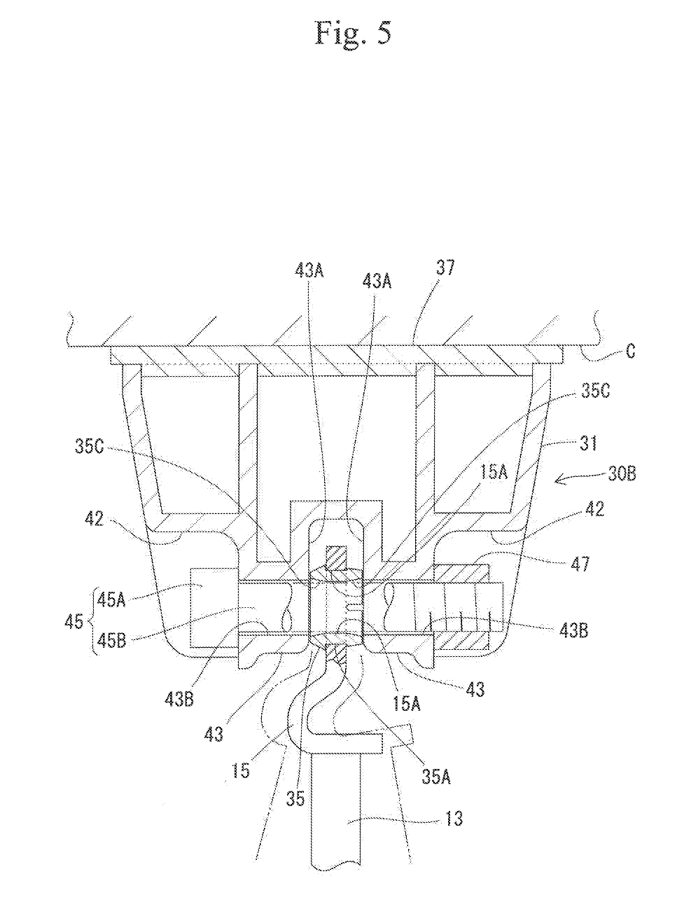

The groove 41 has a pair of convex portions 43 which are formed at a central part thereof in the long side direction to protrude from the bottom 41A and the both inner wall surfaces 41B. A space is defined between the convex portions 43 as illustrated in FIGS. 2 and 5. The joint 15 of the damper 10 and the bush 35 which will be described later are fitted in the space. The space communicates with the groove 41. A distance between the inner walls 43A of the convex portions 43 (a length of the space in the short side direction) is slightly longer than the length of the bush 35. The convex portions 43 respectively have insertion holes 43B which are formed to extend therethrough in the short side direction and through which the shaft part 45B of the bolt 45 is inserted.

In the ceiling-side base 30B, the base body 31 has recesses 42 respectively formed in the middle in the long side direction at both sides of the groove 41. The recesses 42 each have a side in which the insertion hole 43B formed through the convex portion 43 is open. The head 45A of the bolt 45 and the nut 47 screwed onto the bolt 45 are respectively disposed in the recesses 42. The recesses 42 are formed to be spread so that tools can be fitted with the bolt head 45A and the nut 47 from above. Central axes of the respective bolts 45 serve as rotation axes of the dampers 10 in the ceiling-side bases 30B and 30C.

As illustrated in FIG. 5, the bush is substantially cylindrical in shape and is an elastic body. The bush 35 has a length that is slightly smaller than a distance between the inner wall surfaces 43A of the convex portions 43 provided in the base body 31. The bush 35 is formed with a concave portion 35A going around a central part of the outer peripheral surface thereof. The concave portion 35A has an outer diameter that substantially equals an inner diameter of the through hole 15A formed through the joint 15 of the damper 10. The bush 35 has portions rising from both ends of the concave portion 35A which portions have outer diameters larger than the inner diameter of the through hole 15A of the joint 15.

The central part of the bush 35 has an inner diameter slightly larger than an outer diameter of the shaft part 45B of the bolt 45. Both ends of the bush 35 have inner peripheral surfaces 35C the diameters of which are outwardly enlarged. Accordingly, the bush 35 is rotatable about the shaft part 45B of the bolt 45. Furthermore, the bush 35 is inclinable with respect to the shaft part 45B of the bolt 45 to the extent that the inner peripheral surfaces 35C of both ends thereof having enlarged diameters abut against an outer peripheral surface of the shaft part 45B of the bolt 45. In other words, the damper 10 with the bush 35 attached to the joint 15 is rotatable about the shaft part 45B of the bolt 45 and swingable in a direction intersecting the rotation direction. More specifically, the damper 10 is swung due to a dimensional allowance and the enlarged diameter of the inner peripheral surfaces 35C. Furthermore, by the elastic deformation of the bush 35, the dampers 10 can be swung more largely in the direction intersecting the rotation direction.

The slip preventing part 37 has an outer shape which is similar to and slightly larger than the outer shape of the base body 31 (a rectangular shape). The slip preventing part 37 is made of rubber and substantially flat in shape. The slip preventing part 37 is detachably attached to the base body 31 by an elastic force thereof.

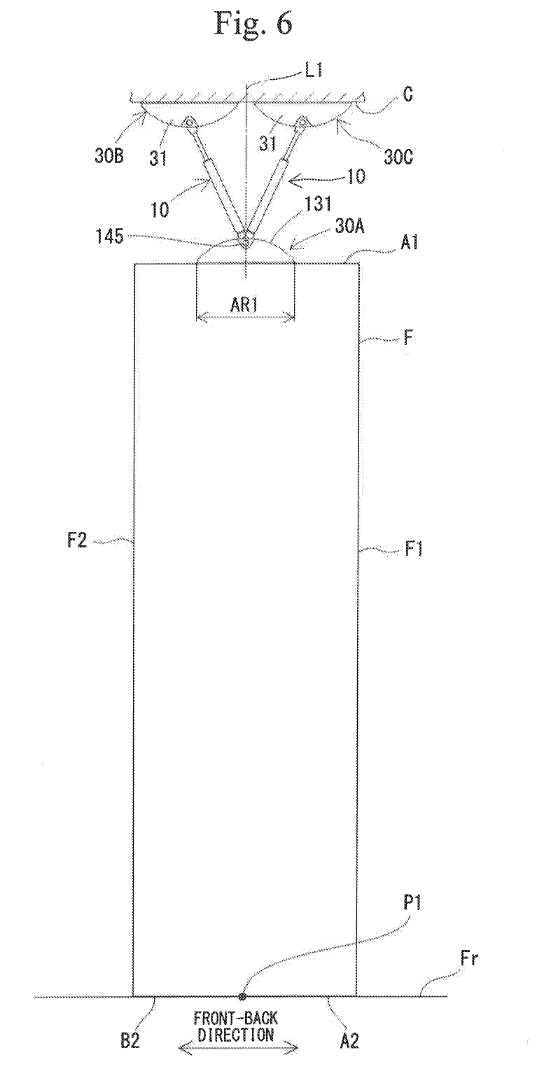

The overturn preventing device 1 constructed as described above is mounted between the top surface A1 of the furniture F (the article) installed on the floor surface Fr (the installation surface) and the ceiling C, as illustrated in FIGS. 1 and 6, for example. One end side of each damper 10 is coupled to the article-side base 30A, and the article-side base 30A is thus used as a base of both dampers 10. On the other hand, the other ends of the dampers 1 are respectively coupled to the ceiling-side bases 30B and 30C.

In the mounted state as illustrated in FIGS. 1 and 6, the ceiling-side bases 30B and 30C are respectively disposed at both sides of an imaginary vertical line L1 passing the central part of the article-side base 30A in the state where the overturn preventing device 1 is mounted between the top surface A1 of the furniture (article) F and the ceiling C. The damper 10 disposed at one side of the imaginary line L1 (the damper 10 coupled to the base 30B) is disposed at an inclination angle θ made between the central axis of the damper 10 and the vertical direction. The other damper 10 disposed at the other side of the imaginary line L1 (the damper 10 coupled to the base 30C) is also disposed at the inclination angle θ made between the central axis of the damper 10 and the vertical direction. In other words, both dampers 10 have the same inclination with respect to the vertical direction. One damper 10 is disposed in a forward inclined state (an inclined state in which the damper is positioned forward as it goes to the upper side), and the other damper 10 is disposed in a backward inclined state (an inclined state in which the damper is positioned backward as it goes to the upper side).

Furthermore, the bottom B2 of the furniture F is formed into an elongated shape (more specifically, a rectangular shape as viewed on the bottom) such that a predetermined direction perpendicular to the height direction of the furniture F (the aforementioned right-left direction) is a longitudinal direction, as illustrated in FIG. 6. Accordingly, when placed on the floor surface Fr, the furniture F is in a state of being tilted easily in the short side direction (the aforementioned front-back direction) perpendicular to the height direction and the longitudinal direction. On the other hand, a center position P1 of the bottom B2 and a location range AR1 of the article-side base 30A overlap in the front-back direction of the furniture F (the direction perpendicular to the height direction and the longitudinal direction). In other words, the center position P1 is located beneath the article-side base 30A.

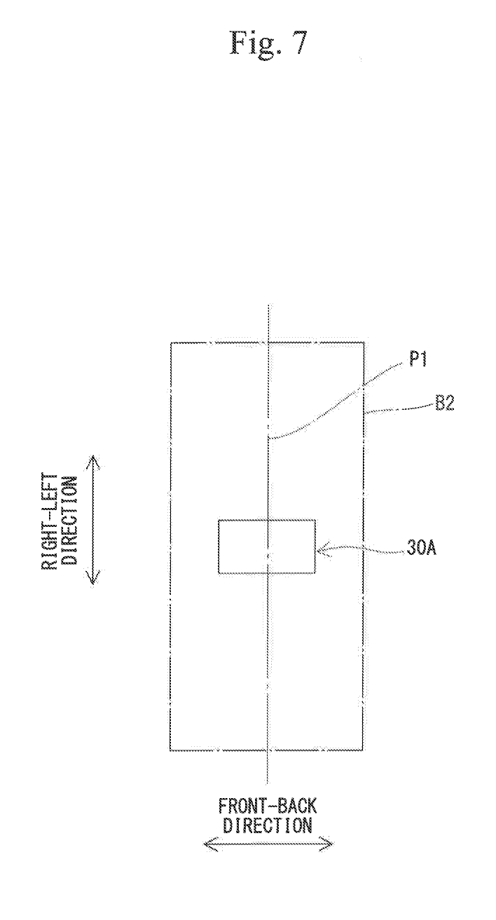

FIG. 7 briefly illustrates a positional relation between the article-side base 30A and the bottom B2 in the case where the article-side base 30A and the furniture F are viewed in a planar view, and illustrates an outer edge shape of the article-side base 30A and an outer edge shape of the bottom B2. The position of the outer edge of the bottom B2 is imaginally presented by the dot-and-dash line. As illustrated in FIG. 7, the center position P1 of the bottom B2 in the front-back direction is located beneath the article-side base 30A. More specifically, the location beneath the location of the central axis of the bolt 145 (namely, the rotation center of the damper 10) is the center position P1 of the bottom B2 in the front-back direction.

When the furniture F on which the overturn preventing device 1 is thus mounted is shaken in the front-back direction by shaking of earthquake or the like thereby to be tilted frontward, the compression damper 10 extending diagonally frontward from the article-side base 30A in surface contact with the top surface A1 of the furniture F is contracted thereby to exert the damping force. As a result, the force tilting the furniture F frontward is reduced by the damper 10, so that an amount of frontward tilt of the furniture F is suppressed. Furthermore, when the furniture F is shaken in the front-back direction thereby to be tilted backward, the compression damper 10 extending diagonally backward from the article-side base 30A in surface contact with the top surface A1 of the furniture F is contracted thereby to exert the damping force. As a result, the force tilting the furniture F backward is reduced by the damper 10, so that an amount of backward tilt of the furniture F is suppressed.

Thus, when the furniture F is tilted by shaking of earthquake or the like in an extending direction of the axes of the compression dampers 10, that is, in the front-back direction of the furniture F, the compression damper 10 mounted between the top surface A1 of the furniture F installed on the floor surface Fr and the ceiling C is contracted. As a result, a damping force is generated whereby a force tilting the furniture F is dampened. Accordingly, an amount of tilt of the furniture F is suppressed with the result that the furniture F can be prevented from overturn. Furthermore, the overturn preventing device 1 can also be mounted to the furniture F which is not installed near the wall surface vertically rising from the floor surface Fr, so that the furniture F can be prevented from overturn. Moreover, a plurality of the dampers 10 can be installed with a sufficient angular inclination even when a top board of the furniture F has a narrow pitch (a front-back dimension of the top surface).

As described above, the overturn preventing device 1 has a plurality of dampers 10, one of ends of each damper 10 is coupled to the article-side base 30A. When the overturn preventing device 1 is to be mounted between the top surface A1 of the furniture F (the article) and the ceiling C, individual bases need not be provided for the respective dampers 10 at the furniture F side, and the common article-side base 30A can be used. As a result, even when the number of dampers is increased, increase in an area of the top surface of the article necessary for installation of the base can be suppressed. Moreover, the plural dampers 10 are coupled to the article-side base 30A, so that the dampers 10 can be controlled in a collective manner. As a result, when the base is to be positioned and placed on the article, time and effort to position and place the individual bases can be eliminated. Furthermore, since the number of bases is reduced, man-hour and cost can be reduced.

Accordingly, a plurality of dampers can be mounted between the top surface A1 of the furniture F (the article) and the ceiling C, and increase in working man-hour and increase in an installation space can be suppressed.

The other ends of the dampers 10 (the ends opposite the article-side base 30A side) are individually coupled to the plurality of ceiling-side bases 30B and 30C. According to this construction, with respect to the article side, the common base is used with the result that increase in working man-hour and increase in an installation space can be suppressed. With respect to the ceiling side, the bases are provided for the respective dampers with the result that the degree of freedom in installation of the overturn preventing device can be increased. In particular, with respect to the article-side base which is subject to the restriction by the size, shape and the like of the top surface of the article, it is possible to adopt a configuration easily adaptable to the restriction due to the article by common usage of the article-side base. On the other hand, with respect to the ceiling side where there may be more space allowance as compared with the article side, the positions of the bases can be set for each damper so that fine adjustment can be made.

The ceiling side bases 30B and 30C are respectively disposed at both sides of the vertical imaginary line L1 passing the central part of the article-side base 30A in the state where the overturn preventing device 1 is mounted between the top surface A1 of the furniture F (the article) and the ceiling C. In this configuration, the central position of the article-side base 30A in the long side direction and the central position in the short side direction are a central part and more specifically, the imaginary line L1 is an imaginary vertical straight line intersecting with the central axis of the bolt 145.

In this construction, one of the dampers 10 is mounted while being inclined to one of the sides of the imaginary line L1 on the basis of the article-side base 30A, and the other damper 10 is mounted while being inclined to the other side. According to this construction, even when the furniture F is tilted to the one side or to the other side, the force tilting the furniture F can be effectively dampened with the result that the tilt of the furniture F can be suppressed. The similar effect can be achieved in the case of an article other than the furniture F.

The above-described effect is noticeable particularly when the overturn preventing device 1 is applied to furniture which is not installed adjacent to a wall surface, that is, non-adjacent furniture. The non-adjacent furniture has a possibility of being tilted to one side and also to the other side of an overturning direction (a direction in which the furniture is tilted easily) since the non-adjacent furniture is not supported by a wall surface, with the result that there has been a problem that the conventional overturn preventing device is difficult to apply to such non-adjacent furniture. However, the overturn preventing device 1 in this construction can be installed so that a damping force is generated even when the furniture is tilted to either one or the other side. Accordingly, the overturn preventing device 1 can effectively be used for the non-adjacent furniture.

In the overturn preventing device 1, the inclinations of the damper 10 disposed at one side of the imaginary line L1 with respect to the vertical direction and the inclinations of the damper 10 disposed at one side of the imaginary line L1 with respect to the vertical direction are equal to each other. According to this construction, the forces tilting the furniture F to the one side and the force tilting the article to the other side can be dampened in a balanced manner.

The bottom B2 of the furniture F is formed into an elongated shape such that a predetermined direction (the right-left direction) perpendicular to a height direction of the furniture F is a longitudinal direction. The center position of the bottom B2 and the location range AR1 of the article-side base 30A overlap in the front-back direction of the furniture F (the direction perpendicular to the height direction and the longitudinal direction). In other words, the center position of the bottom B2 in the front-back direction is located beneath the article-side base 30A. The furniture F is tilted easily in the direction (the front-back direction) perpendicular to the longitudinal direction (the right-left direction) of the bottom B2, so that uplift due to the tilt is likely to occur at both ends (that is, a front end and a rear end) of the bottom B2 in the perpendicular direction. Accordingly, when the overturn preventing device is configured so that the center position of the article bottom (the center position of the furniture F in the front-back direction) is located beneath the article-side base 30A, the uplift can be prevented from leaning to one of the ends of article bottom. This can prevent tilt at both sides in the direction perpendicular to the longitudinal direction of the article in a balanced manner.

### Second Embodiment

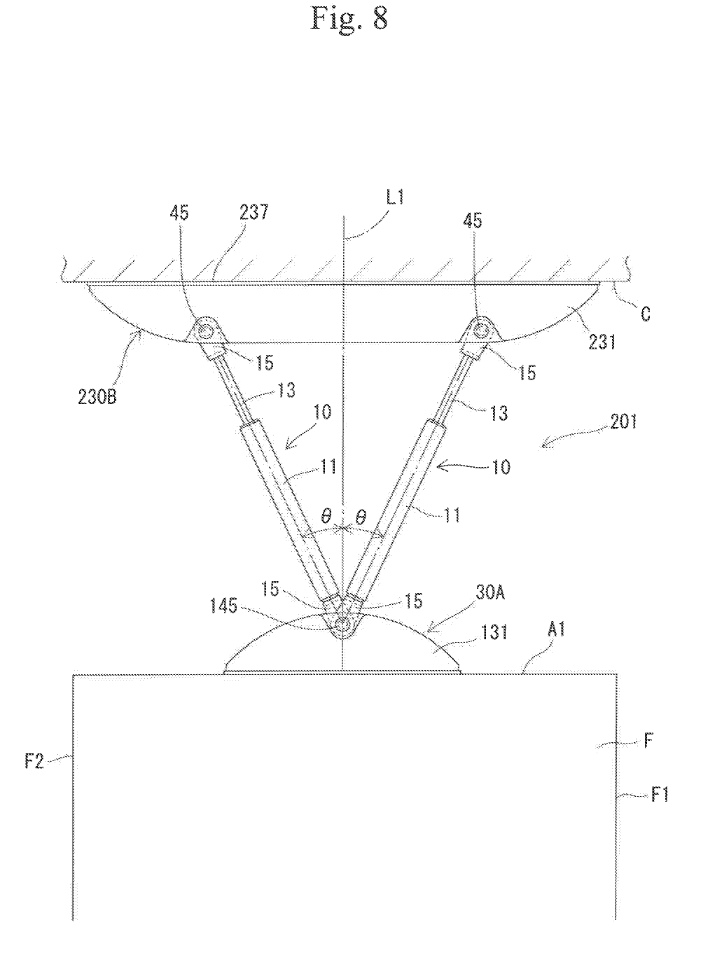

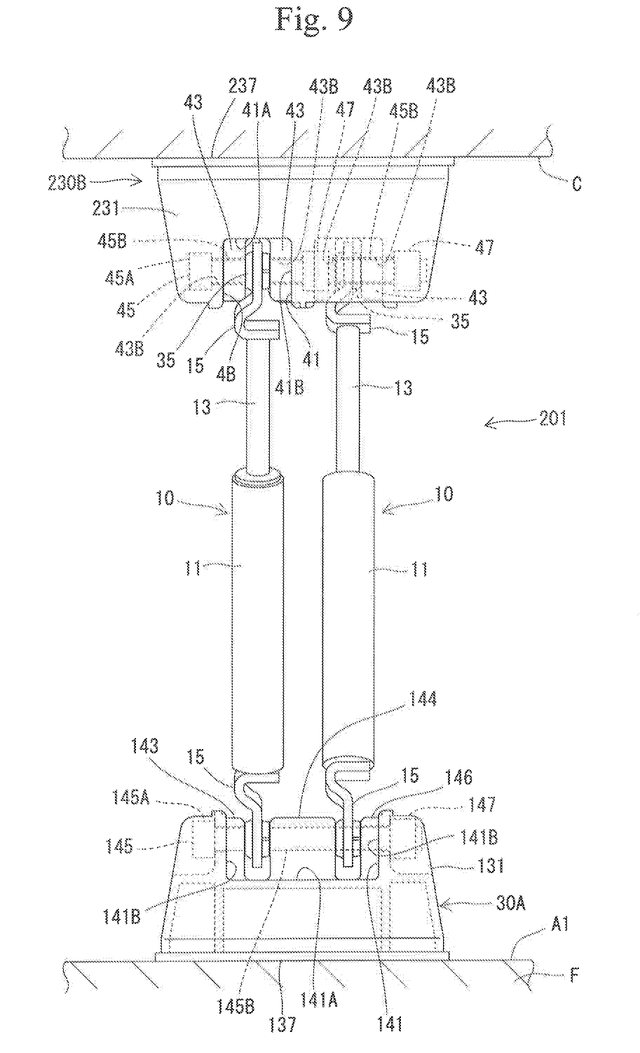

Next, the overturn preventing device of a second embodiment will be described with reference to FIGS. 8, 9 and so on.

The overturn preventing device 201 of the second embodiment differs from that of the first embodiment in that the plural ceiling-side bases 30B and 30C (FIG. 1 and so on) provided in the first embodiment are integrated into a common ceiling-side base 230B. The second embodiment is identical with the first embodiment in the other respects. Accordingly, identical or similar parts in the second embodiment are labelled by the same reference symbols as those in the first embodiment and detailed description of these parts will be eliminated.

As illustrated in FIGS. 8 and 9, the other ends of two dampers 10 (the ends opposed to the article-side base 30A) are coupled to different positions on the common ceiling-side base 230B.

The connecting structure between the base body 231 of the common ceiling-side base 230B and two dampers 10 is same as that between the two base bodies 31 and the two dampers 10 in the first embodiment. The common ceiling-side base 230B as illustrated in FIGS. 8 and 9 is provided with two convex portions 43 and two insertion holes 43B having the same positional relationship as the two convex portions 43 and the two insertion holes 43B formed in the ceiling-side base 30B (refer to FIGS. 2, 5 and so on) in the first embodiment. Furthermore, the ceiling-side base 230B is also provided with two convex portions 43 and two insertion holes 43B having the same positional relationship as the two convex portions 43 and the two insertion holes 43B (refer to FIGS. 2, 5 and so on) formed in the ceiling-side base 30C in the first embodiment. Two sets of a combination of the bolt 45 and the nut 47 are provided on the ceiling-side base 230B as illustrated in FIGS. 8 and 9 in the same positional relationship as two sets of the combination of the bolt 45 and the nut 47 in the first embodiment. According to the above-described structure, the shaft parts 45B of the two bolts 45 are positioned so as to be in parallel to each other, and the centers of the shaft parts 45B respectively serve as rotation axes of the dampers 10.

When the ceiling-side bases 30B and 30C as illustrated in FIGS. 2, 5 and so on is to be changed to the common ceiling-side base 230B as illustrated in FIGS. 8 and 9, the width of the base body 231 is slightly increased, so that both parts coupled to both dampers 10 are disposed so as to be displaced to the widthwise sides, respectively. In this regard, for example, portions corresponding to the respective recesses 42 (FIG. 5) may be configured deeper in the width direction. For example, the recess to house the nut 47 out of a pair of recesses (parts similar to the recesses 42 in FIG. 5) to house the bolt 45 and nut 47 located on the front side in FIG. 9 may be configured deeper in the width direction (an axial direction of the bolt 45). Furthermore, the recess to house the bolt 45 out of a pair of recesses (parts similar to the recesses 42 in FIG. 5) to house the bolt 45 and nut 47 located in the back in FIG. 9 may be configured deeper in the width direction (the axial direction of the bolt 45). Thus, two pairs of bolts 45 and nuts 47 can be retained in a parallel relationship as illustrated in FIGS. 8 and 9, and the joints 15 of the two dampers 10 can rotatably be mounted on the respective bolts 45. The slip preventing part 237 is made of rubber and is substantially flat in shape. The slip preventing part 237 has an outer shape that is similar to and slightly larger than the base body 231 (a rectangular shape). The slip preventing part 237 is detachably attached to the base body 231 by an elastic force thereof.

FIGS. 8 and 9 illustrate an example of the holding structure in the common ceiling-side base 230B. However, the illustrated structure is a mere example, and the holding structure in the ceiling-side base 230B may take any configuration as long as it can rotatably hold the other ends of the two dampers 10 and the rotation axes of these ends (central axes of rotation) are parallel and are spaced from each other.

In the overturn preventing device 201 as illustrated in FIGS. 8 and 9, the one ends of the dampers 10 are rotatably held by the common shaft member (the bolt 145) of the article-side base 30A, so that the two dampers 10 are rotatable about the common rotation axis. And, the other ends of the dampers 10 are rotatably held by the respective shaft members (two bolts 45) of the common ceiling-side base 230B, so that the dampers 10 are rotatable about the respective rotation axes (parallel rotation axes).

In the state where the overturn preventing device 201 as illustrated in FIG. 8 is mounted between the top surface A1 of the furniture F and the ceiling C, the other ends of the dampers 10 are respectively disposed at both sides of the imaginary vertical line L1 (similar to the imaginary line L1 in the first embodiment) passing the central part of the article-side base 30A. One of the dampers 10 is inclined to one side of the imaginary line L1, and the other damper 10 is inclined to the other side of the imaginary line L1. The inclination angle 9 of the damper 10 disposed at one side of the imaginary line L1 with respect to the vertical direction equals the inclination angle θ of the damper 10 disposed at the other side of the imaginary line L1 with respect to the vertical direction. Furthermore, also in this example, the bottom B2 of the furniture F may be formed into an elongated shape such that a predetermined direction perpendicular to the height direction of the furniture F is a longitudinal direction, as in the first embodiment (FIGS. 6, 7). And, as in the first embodiment, the center position of the bottom B and the location range of the article-side base 30A may overlap in the perpendicular direction which is perpendicular to the height direction of the furniture F and the longitudinal direction.

According to the above-described overturn preventing device 201, the number of parts can be reduced by common usage of the base at the ceiling side as well as the article side, with the result that the cost reduction can easily be achieved. Furthermore, since the number of parts to be installed at the ceiling side is reduced, increase in working man-hour can be suppressed.

Furthermore, the angles of dampers 10 are fixed to predetermined angles. As a result, the overturn preventing device 201 can effectively applied to a usage which requires no change in the angles of both dampers 10, a usage in which angular changes need not be carried out, a usage in which angular changes are undesirable, and so on.

The present invention should not be limited to the embodiments described above with reference to the drawings, but the technical scope of the invention encompasses the following embodiments, for example.

(1) Although the overturn preventing device is mounted on the furniture in each of the first and second embodiments, the overturn preventing device may be mounted on articles such as a bookshelf or a refrigerator which has a possibility of overturned by shaking of earthquake or the like.
(2) Although the overturn preventing device 1 is mounted on the furniture placed on the floor surface Fr in the manner such that no article is opposed to the front F1 and the back F2, in each of the first and second embodiments, the overturn preventing device may be mounted on the furniture placed on the floor surface Fr with the back F2 being adjacent to the wall surface W, or the like.
(3) The front, sides and the like of the overturn preventing device are presented for descriptive purposes in each of the first and second embodiments. However, these are concepts different from the front, sides and the like of the furniture. In other words, the front of the furniture and the front of the overturn preventing device do not necessarily correspond to each other. The overturn preventing device can be mounted in various directions relative to the direction of the furniture.
(4) Although the configuration including two dampers is presented in each of the first and second embodiments, three or more dampers may be provided. In this case, the ceiling-side bases to be connected these dampers may be provided separately for each damper, and alternatively, all or some of the ceiling-side bases may be integrated.
(5) In each of the first and second embodiments, both ends of the damper are respectively coupled to the bases so as to be rotatable about the rotation axes and swingable in the direction intersecting the rotation direction. However, both ends of the dampers may not be coupled to the bases so as to be rotatable or swingable.
(6) Although all of the dampers 10 are compression dampers in each of the first and second embodiments, all dampers may be two-way dampers in which a damping force generated in an extending operation equals a damping force generated in a contracting operation. Alternatively, all dampers may be extension dampers in which a damping force generated in an extending operation is larger than a damping force generated in a contracting operation. Further alternatively, a plurality of types of dampers may be used in a mixed manner.
(7) Although the damper enclosing a hydraulic fluid and a compressed gas in the a cylinder is used in each of the first and second embodiments, a fluid-pressure damper enclosing another fluid or another type of damper may be used as long as it can exert a predetermined damping force in a contracting operation.
(8) In each of the first and second embodiments, the compressed gas is enclosed in the cylinder so that an expansion force of the compressed gas acts in an extension direction. However, a force acting in the extension direction may be generated by another manner.

### EXPLANATION OF REFERENCE SYMBOLS

1, 201 . . . overturn preventing device; 10 . . . damper; 30A . . . article-side base; 30B, 30C . . . ceiling-side base; 230B . . . ceiling-side base (common ceiling-side base); B2 . . . bottom; C . . . ceiling; F . . . furniture (article); Fr . . . floor surface (installation surface); and L1 . . . imaginary line.

1. An overturn preventing device comprising:
a plurality of dampers to be mounted between a top surface of an article installed on an installation surface and a ceiling;
an article-side base to be placed on the top surface of the article, the dampers each having first and second ends, all of the first ends of the dampers being configured to be coupled to the article-side base; and
one or a plurality of ceiling-side bases to which the second ends of the dampers are coupled.

2. The overturn preventing device according to claim 1, wherein the second ends of the dampers are individually coupled to the respective ceiling-side bases.

3. The overturn preventing device according to claim 1, wherein the second ends of a plurality of or all of the dampers are coupled to different positions of a common ceiling-side base.

4. The overturn preventing device according to claim 1, wherein the ceiling-side bases are respectively disposed at both sides of an imaginary vertical line passing a central part of the article-side base in a state where the overturn preventing device is mounted between the top surface of the article and the ceiling.

5. The overturn preventing device according to claim 4, wherein the damper disposed at one of the sides of the imaginary line has a first inclination to a vertical direction and the damper disposed at the other side of the imaginary line has a second inclination to a vertical direction, the first and second inclinations being equal to each other.

6. The overturn preventing device according to claim 1, wherein:
the article has a bottom which is formed into an elongated shape such that a predetermined direction perpendicular to a height direction of the article is a longitudinal direction; and
a center position of the bottom and a location range of the article-side base overlap in a direction perpendicular to the height direction of the article and the longitudinal direction.

7. The overturn preventing device according to claim 2, wherein:
the ceiling-side bases are respectively disposed at both sides of an imaginary vertical line passing a central part of the article-side base in a state where the overturn preventing device is mounted between the top surface of the article and the ceiling;
the damper disposed at one of the sides of the imaginary line has a first inclination to a vertical direction and the damper disposed at the other side of the imaginary line has a second inclination to a vertical direction, the first and second inclinations being equal to each other;
the article has a bottom which is formed into an elongated shape such that a predetermined direction perpendicular to a height direction of the article is a longitudinal direction; and
a center position of the bottom and a location range of the article-side base overlap in a direction perpendicular to the height direction of the article and the longitudinal direction.

8. The overturn preventing device according to claim 3, wherein:
the ceiling-side bases are respectively disposed at both sides of an imaginary vertical line passing a central part of the article-side base in a state where the overturn preventing device is mounted between the top surface of the article and the ceiling;
the damper disposed at one of the sides of the imaginary line has a first inclination to a vertical direction and the damper disposed at the other side of the imaginary line has a second inclination to a vertical direction, the first and second inclinations being equal to each other;
the article has a bottom which is formed into an elongated shape such that a predetermined direction perpendicular to a height direction of the article is a longitudinal direction; and
a center position of the bottom and a location range of the article-side base overlap in a direction perpendicular to the height direction of the article and the longitudinal direction.
